(19) United States
(12) Patent Application Publication
(10) Pub. No.: US 2016/0359214 A1
(43) Pub. Date: Dec. 8, 2016

(54) At-Home Fuel Cell Vehicle Refueling System and Method

(71) Applicant: Richard Harris Barham Barton, San Diego, CA (US)

(72) Inventor: Richard Harris Barham Barton, San Diego, CA (US)

(21) Appl. No.: 15/152,418

(22) Filed: May 11, 2016

Related U.S. Application Data
(60) Provisional application No. 62/170,013, filed on Jun. 2, 2015.

(51) Int. Cl. H01M 16/00; H01M 8/06; H01M 8/04291; H01M 8/043; H01M 8/0202; H01M 8/04276

(52) U.S. Cl. CPC H01M 16/003; H01M 8/0202; H01M 8/04283; H01M 8/04291; H01M 8/043; H01M 8/0693

(57) ABSTRACT

A fuel cell vehicle on-board system and method for at-home refueling of the fuel cell vehicle. When home fueling is desired, an electric source is plugged into the vehicle and an on-board reversible fuel cell, in an electrolyzer mode, converts stored water to hydrogen gas and transfers it to an on-board pressurized storage tank.

### CROSS REFERENCE TO RELATED APPLICATION

This application claims the benefit of U.S. Provisional Patent Application No. 62/170,013 filed Jun. 2, 2015, which is incorporated by reference herein.

### FIELD OF THE INVENTION

The present invention relates to systems and methods for at-home refueling of fuel cell vehicles.

### BACKGROUND OF THE INVENTION

The combustion of gasoline and diesel to transport people and goods is the second largest generator of carbon dioxide gas, comprising 31% of total US CO2 emissions in 2013. Of the transportation segment, personal vehicles are the single largest contributor. For this reason, California has enacted strict laws, called California's Zero Emissions Vehicle (ZEV) Program, that require by 2025 one-sixth of all auto sales in California be zero emissions vehicles. The most promising zero emissions vehicles are electric and fuel cell vehicles, but both have limitations that prevent their wider acceptance.

Electric vehicles have the advantages of low per-mile cost and the convenience of at-home charging. These advantages, however, are offset by significant disadvantages. With the exception of the Tesla Model S, electric vehicles have a range of 60 to 100 miles. A longer range costs more. The Tesla Model S has a range of 300 miles, but is significantly more expensive than the shorter-range models offered by other auto manufacturers. Another disadvantage is charging time, typically overnight for slow charging systems. Fast chargers significantly reduce this time to 20 minutes for a maximum 80% charge. Twenty minutes, however, is still an inconvenient time for charging. Fast charging may have another potential drawback. The long-term effect of fast charging on battery life is unknown. Nissan recommends limiting the use of fast charging for their electric vehicles. Since battery packs are expensive, loss of battery life adds another potential cost from fast charging.

Because of the current limitations, electric vehicles have not gained wider acceptance. They currently serve a niche market, with 250,000 to 400,000 vehicles estimated to be on US roads by the end of 2015, out of 250 million registered vehicles. The electric vehicle market growth in 2015 is expected to be flat, with 2015 sales equaling the level of 2014 sales.

Fuel cell vehicles have the advantages of better range and relatively quick refueling times. For its Mirai fuel cell vehicle, Toyota claims a range of 300 miles and a refueling time of approximately 5 minutes. The disadvantage of fuel cell vehicles is the lack of a hydrogen infrastructure to support the vehicles. Currently, there are fewer than 50 public hydrogen fueling stations in the US. Manufacturers will not sell fuel cell vehicles in cities without a sufficient number of hydrogen filling stations. This limitation results in fuel cell vehicles being available only in a small portion of the United States. Toyota plans to sell or lease the Mirai in only the three cities in southern California. Likewise, Hyundai plans to lease its fuel cell vehicles in this same general area. Plans for sales in other parts or the country are contingent on the building of regional fueling stations. Conversely, there is little incentive to build hydrogen filling stations if there are not sufficient fuel cell vehicles to support them.

This limitation can be overcome with at-home refueling of fuel cell vehicles. Home refueling gives fuel cell vehicles the major advantage of electric vehicles. The fuel cell vehicle can be refueled at home, or in any place with access to electricity. A vehicle with a range of approximately 300 miles that can be refueled quickly at a refueling station or overnight at home gives fuel cell vehicles advantages even over gasoline powered vehicles. This will open the fuel cell market to more consumers. Once more vehicles are sold, there will be more incentive to create the hydrogen infrastructure to support the vehicles.

The current state of the art of hydrogen generation for home refueling of fuel cell vehicles has its own limitations. Some proposals include having a home fueling station, for example in the garage, using stand-alone equipment to generate hydrogen gas through electrolysis of water. The hydrogen gas is stored for later fueling of the vehicle. Other proposals include systems that use fuel cells to process fossil fuels, such as natural gas, to generate hydrogen through a process called reformation. All these systems have the limitation of capacity—the systems proposed are too small to produce enough hydrogen gas overnight to completely refuel a vehicle. One proposed system produces the hydrogen-gas equivalent of 2 gallons of gasoline in a 12 hour period. Systems that could have increased capacity require larger electrolysis or reformation equipment, making them cost prohibitive. Other disadvantages are that they require a source of purified water (for electrolysis) or fossil fuel (for reformation), a large pressurized storage tank for the hydrogen gas, and equipment to transfer the gas to the vehicle.

If the problem of the hydrogen infrastructure was solved, fuel cell vehicles would be the vehicles of choice for most consumers. What is needed is a home fuel cell refueling station that is simple, inexpensive, and can refuel the vehicle in a shorter period time.

### SUMMARY OF THE INVENTION

An aspect of the invention involves a fuel cell vehicle on-board system and method for at-home refueling of the fuel cell vehicle. This aspect of the invention overcomes the above-described disadvantages with prior fuel cell vehicle home refueling systems, making home fueling as easy as charging an electric vehicle. When home fueling is desired, an electric source would be plugged into the vehicle, as would be done for an electric vehicle. The vehicle's on-board equipment would convert stored water to hydrogen gas and transfer it to the on-board pressurized storage tank. The vehicle's existing fuel cell would be a reversible fuel cell, allowing it to be run in the electrolyzer mode. Fuel cell vehicles have substantially larger fuel cells than those proposed for home fueling stations. Proposals for home fuel cells are in the range of 1 to 5 kW, whereas vehicle fuel cells are in the range of 100 kW, giving increased capacity for generating hydrogen gas. The vehicle's system would be capable of refueling in a 12 hour period. The vehicle would also have the option of being refueled at an existing hydrogen fueling station. Electrical energy from vehicle sources, such as regenerative braking, can be used to generate additional hydrogen gas in the electrolyzer mode.

One or more implementations of the aspect of the invention described immediately above includes one or more of the following: the system captures the byproduct of the hydrogen-oxygen reaction, water; the water is stored in an on-board tank in the automobile; the tank is electrically heated, as needed, to prevent freezing in cold weather and to improve the efficiency of electrolysis; the tank also has equipment to prevent microbial growth in the water; the system includes a tube into the water tank; the tube allows evacuation of the water by vacuum or the ability to fill the water tank, as needed; an electrical port supplies the vehicle with electricity from an outside source, similar to the method used to charge an electric vehicle; the current is used to power the reversible fuel cell in the electrolyzer mode; the water is fed back to the reversible fuel cell when the fuel cell is in the electrolyzer mode; a system of pumps compress the hydrogen gas generated by the reversible fuel cell in the electrolyzer mode; the compressed gas is stored in the on-board hydrogen pressurized tanks; the oxygen is vented to the atmosphere; a system of valves allows the hydrogen tank to be filled from an external source, such as a hydrogen filling station; as part of the refueling process, the water tank can be drained to allow the filling station to reclaim the purified water; and/or the hydrogen filling nozzle can also have a port for recapturing the water by vacuum.

A further aspect involves a fuel cell vehicle on-board system for a fuel cell vehicle powered by an electric motor comprising one or more reversible fuel cells powered by compressed hydrogen gas and oxygen, the one or more reversible fuel cells supplying power to the electric motor in a power mode and supply hydrogen gas in an electrolyzer mode; a water supply and capture system to supply water to the one or more reversible fuel cells in an electrolyzer mode and capture water from the one or more reversible fuel cells in a power mode, where water is the byproduct of the hydrogen-oxygen reaction in the one or more reversible fuel cells; a hydrogen gas supply and capture system to capture hydrogen gas from the one or more reversible fuel cells in the electrolyzer mode and supply hydrogen gas to the one or more reversible fuel cells in a power mode; one or more electrical connectors for externally supplying electrical power to the one or more reversible fuel cells to power the one or more reversible fuel cells in the electrolyzer mode to supply hydrogen gas to the hydrogen gas supply and capture system.

One or more implementations of the aspect of the invention described immediately above includes one or more of the following: the hydrogen gas supply and capture system includes one or more on-board hydrogen gas tanks that store hydrogen gas in the fuel cell vehicle, and one or more pumps that draw hydrogen gas from and deliver hydrogen gas to the one or more on-board hydrogen gas tanks, and compress the hydrogen gas generated by the one or more reversible fuel cells; the water supply and capture system includes one or more on-board water tanks that store water in the fuel cell vehicle, and one or more pumps to draw water from and deliver water to the water tank; the water supply and capture system includes one or more heating elements to heat the water in the water tank; a vent that in the electrolyzer mode allows oxygen gas by-product from the one or more reversible fuel cells to be vented to the atmosphere; a connection so that the hydrogen gas supply and capture system can be filled from an external gas source such as a hydrogen filling station; the fuel cell vehicle is a hybrid fuel cell electric vehicle including a rechargeable power source, and the one or more electrical connectors are also used for charging the rechargeable power source of the hybrid fuel cell electric vehicle; the one or more reversible fuel cells each include a power rating greater than 5 kW; the one or more reversible fuel cells each include a power rating greater of about 100 kW.

A still further aspect of the invention involves a method of at-home refueling of a fuel cell vehicle having the fuel cell vehicle on-board system of the aspect of the invention described most immediately above comprising supplying water from the water supply and capture system to the one or more reversible fuel cells; at home, coupling an electric source with the one or more reversible fuel cells with the one or more electrical connectors to externally supply electrical power to the one or more reversible fuel cells to power the one or more reversible fuel cells in an electrolyzer mode; converting stored water to hydrogen gas with the one or more reversible fuel cells in an electrolyzer mode; supplying hydrogen gas from the one or more reversible fuel cells in an electrolyzer mode to the hydrogen gas supply and capture system; and storing hydrogen gas in the hydrogen gas supply and capture system.

One or more implementations of the aspect of the invention described immediately above includes one or more of the following the hydrogen gas supply and capture system includes an on-board pressurized storage tank, and storing hydrogen gas includes storing hydrogen gas in the on-board pressurized storage tank; the fuel cell vehicle on-board system is capable of refueling the hydrogen gas supply and capture system in a 12 hour period; regenerative breaking using the electric motor, supplying electrical power to the one or more reversible fuel cells to power the one or more reversible fuel cells in the electrolyzer mode to supply hydrogen gas to the hydrogen gas supply and capture system; the water supply and capture system includes an on-board tank in the vehicle, and the water generated by the one or more reversible fuel cells in the power mode is stored in the on-board tank in the vehicle; the water supply and capture system includes a heater to electrically heat the water in the on-board tank to at least one of prevent freezing in cold weather and improve electrolysis efficiency; venting oxygen supplied by the one or more reversible fuel cells in an electrolyzer mode is vented to the atmosphere; the hydrogen gas supply and capture system includes one or more gas compression pumps and one or more surge tanks, the method further comprising pressurizing the hydrogen gas using the hydrogen gas supply and capture system to approximately 5,000 to 10,000 psi; the fuel cell vehicle on-board system further includes a connection so that the hydrogen gas supply and capture system can be filled from an external gas source such as a hydrogen filling station, and the method further comprising refilling the hydrogen gas supply and capture system with hydrogen gas from the hydrogen filling station via the connection; the fuel cell vehicle is a hybrid fuel cell electric vehicle including a rechargeable power source, and the method further comprising using the one or more electrical connectors for charging the rechargeable power source of the hybrid fuel cell electric vehicle; and/or the one or more reversible fuel cells each include a power rating greater than 5 kW.

Another aspect of the invention is the same as that described above except with modifications to use a liquid fuel for the fuel cell instead of compressed hydrogen. Promising liquid fuels are formic acid or methanol.

One or more implementations of the aspect of the invention described immediately above including a liquid fuel includes one or more of the following: the high pressure hydrogen tank would be replaced with a tank to capture the byproduct gas from liquid fuel reaction; for formic acid or methanol, the byproduct gas is carbon dioxide. The gas is compressed with pumps and stored in the high pressure tank; a tank stores the liquid fuel; the fuel is fed to the fuel cell with a pump; a system captures the water byproduct of the fuel cell reaction; the water is stored in an on-board tank in the automobile; the tank is electrically heated, as needed, to prevent freezing in cold weather and to improve the efficiency of liquid fuel generation; the tank also has equipment to prevent microbial growth in the water; a tube is in the water tank; the tube will allow evacuation of the water by vacuum or the ability to fill the water tank, as needed; an electrical port supplies the vehicle with electricity from an outside source, similar to the method used to charge an electric vehicle. The current is used to power the reversible fuel cell in the electrolyzer mode; a method feeds the water back to the reversible fuel cell when the fuel cell is in the electrolyzer mode; a system feeds the carbon dioxide gas from the pressurized tank to the reversible fuel cell in the electrolyzer mode. The oxygen byproduct from the electrolyzer process is vented to the atmosphere; a system of valves allows the liquid fuel tank to be filled from an external source, such as a fuel cell filling station. As part of the refueling process, the water tank is drained to allow the filling station to reclaim the purified water; and/or the liquid nozzle can also have a port for recapturing the water by vacuum.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is a schematic of an embodiment of a fuel cell vehicle on-board system and method for at-home refueling of the fuel cell vehicle shown in a power mode;

FIG. 2 is a schematic of the fuel cell vehicle on-board system and method of FIG. 1, but is shown in an electrolyzer mode.

FIG. 3 is a schematic of another embodiment of a fuel cell vehicle on-board system and method with modifications to use a liquid fuel for the fuel cell instead of compressed hydrogen for at-home refueling of the fuel cell vehicle, and is shown in a power mode;

FIG. 4 is a schematic of the fuel cell vehicle on-board system and method of FIG. 3, but is shown in an electrolyzer mode.

### DESCRIPTION OF EMBODIMENTS OF THE INVENTION

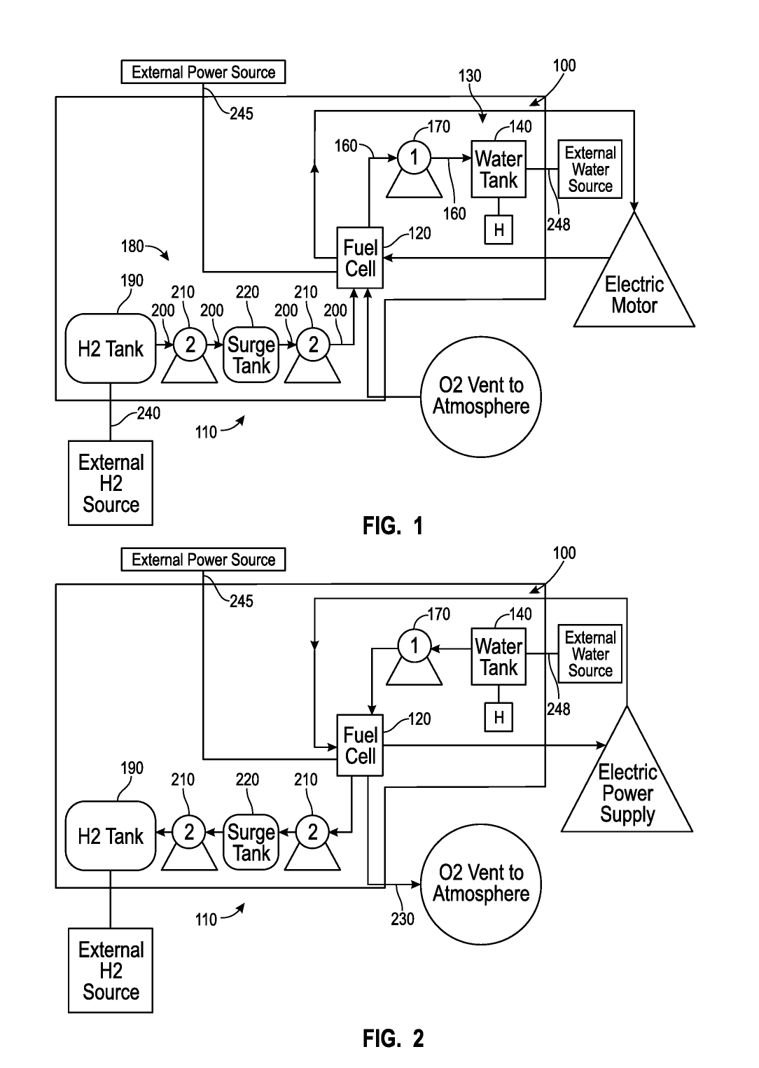

With reference to FIGS. 1 and 2, an embodiment of a fuel cell vehicle on-board system (“system”) 100 and method for at-home refueling of a fuel cell vehicle 110 will be described.

The system 100 includes one or more reversible fuel cells 120 powered by compressed hydrogen gas and atmospheric oxygen. The system 100 includes a water supply and capture system 130 to supply water to the reversible fuel cell 120 in an electrolyzer mode (FIG. 2) and capture water from the reversible fuel cell 120 in a power mode (FIG. 1), where water is the byproduct of the hydrogen-oxygen reaction in the reversible fuel cell 120. The water supply and capture system 130 includes one or more on-board water tanks 140 that store water in the fuel cell vehicle 110. The water supply and capture system 130 may include heating element(s) H to heat the water in the water tank 120 to prevent freezing in cold weather and/or improve electrolysis efficiency. Tube(s) 160 or other connection(s) communicate water to/from the water tank 140. One or more pumps 170 are used to draw water from or deliver water to the water tank 140.

The system 100 includes a hydrogen gas supply and capture system 180 to capture hydrogen gas from the reversible fuel cell 120 in an electrolyzer mode (FIG. 2) and supply hydrogen gas to the reversible fuel cell(s) 120 in a power mode (FIG. 1). The hydrogen gas supply and capture system 180 includes one or more on-board hydrogen gas tank(s) 190 that store hydrogen gas in the fuel cell vehicle 110. Tube(s) 200 or other connection(s) communicate hydrogen gas to/from the hydrogen gas tank(s) 190. Pump(s) 210 is/are used to draw hydrogen gas from or deliver hydrogen gas to/from the hydrogen gas tank(s) 190. The pump(s) 210 compress the hydrogen gas generated by the reversible fuel cell 120 in the electrolyzer mode (FIG. 2). The compressed gas is stored in on-board hydrogen pressurized tanks 190, 220.

In the electrolyzer mode (FIG. 2), oxygen gas by-product from the fuel cell 120 is vented to the atmosphere through one or more ports, outlets, tubes, and/or connections 230. In the power mode (FIG. 1), oxygen gas is supplied from the atmosphere to the fuel cell cathode.

The system 100 includes one or more ports, nozzles, outlets, tubes, valves, and/or connections 240 so that the hydrogen tank 190 can be filled from an external gas source such as a hydrogen filling station.

The system 100 includes one or more electrical receptacles, ports, plugs, and/or connections 245 for externally supplying electrical power to the fuel cell 120 (current will be used to power the reversible fuel cell 120 in the electrolyzer mode (FIG. 2) and/or for charging a rechargeable power source where the vehicle 110 is a hybrid fuel cell/electric vehicle for at-home re-fueling/re-charging.

As part of the refueling process, the water tank(s) 140 can be drained to allow the filling station to reclaim the purified water. The hydrogen nozzle 240 can also have a port for recapturing the water by vacuum.

In the fuel cell power mode of FIG. 1, hydrogen gas is supplied to the fuel cell anode from the hydrogen gas supply and capture system 180. Atmospheric oxygen is supplied to the fuel cell cathode. The electricity generated from the fuel cell reaction is used to power the vehicle. The byproduct of the fuel cell reaction, water, is pumped to the on-board water storage tank 140 via pump(s) 170. The heating element H is used to maintain the temperature of the water in the tank 140 above freezing in cases where the outside temperature is below freezing. The storage tank 140 may have a UV light or other means of reducing microbial growth in the water, if needed. The storage tank 140 contains an evacuation tube (not shown) or drainage port to allow the removal of water, if needed. It may be desirable to remove the water if the vehicle is refueled by adding pressurized hydrogen to the hydrogen tank 190 at a hydrogen refueling station. The water can be a source of purified water for the hydrogen station to recycle for further water electrolysis. The tank(s) 140 would also have a purified water filling port 248 to resupply the water tank 140, if needed. One method of removing the water is supplying a vacuum to the evacuation tube, although other methods such as pumps or gravity drainage are also possible.

Besides home refueling, the system 100 would have the ability to supply pressurized hydrogen directly to the hydrogen storage tank 190. It would be similar to the current methods of remote refueling of the vehicle. The pressurized hydrogen would bypass the gas compression pumps 210. The fuel cell 120 is equipped with the necessary equipment, such as gauges, meters, pressure equalizer's, and pumps, to allow the reversible fuel cell 120 to run in the electrolyzer mode (FIG. 2). For home refueling, an external power source 250 is connected to the vehicle 110. The electric port 245 use the same technology as the electric ports on electric vehicles. Water is fed to the fuel cell(s) 120 by a pump(s) 170. Since electrolysis is an endothermic reaction, the efficiency of electrolysis can be improved by heating the water using the water tank heating element(s) H. The electrolysis process generates hydrogen and oxygen gases. The oxygen gas is vented to the atmosphere. The hydrogen gas is fed to the hydrogen storage tank(s) 190. Gas compression pumps 210 and surge tank(s) 220 are used to pressurize the hydrogen gas to approximately 5,000 to 10,000 psi.

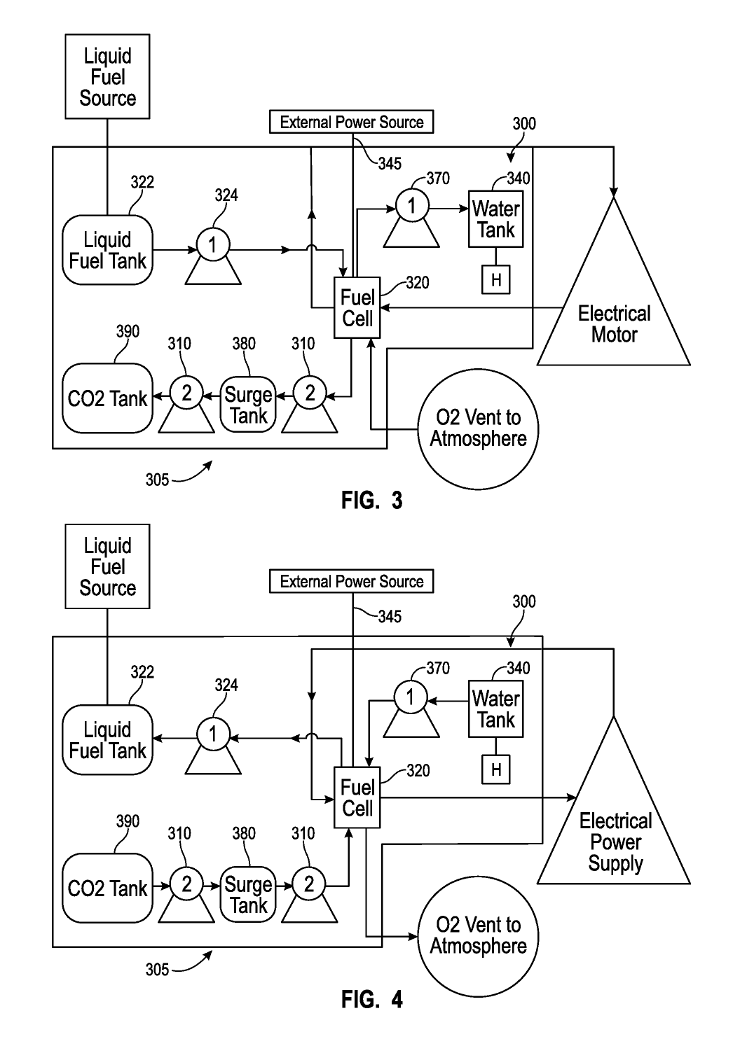

With reference to FIGS. 3 and 4, an alternative embodiment of a system 300 is the same as the system 100 shown and described above with respect to FIGS. 1 and 2, except with modifications to use a liquid fuel (e.g., formic acid, methanol) for a fuel cell 320 instead of compressed hydrogen.

FIG. 3 shows the operation of the formic acid fuel cell(s) 320 in the power mode. Formic acid in a liquid storage tank(s) 322 is supplied by pump(s) 324 to the anode side of the fuel cell 320. Atmospheric oxygen is supplied to the fuel cell cathode. The electricity generated from the fuel cell reaction is used to power vehicle 305. The byproducts of formic acid fuel cells are CO2 and water. The CO2 byproduct is stored in a pressured on-board tank 390. One method for accomplishing this is shown in FIG. 4 through the use of gas compression pumps 310 and a surge tank 320.

Similar to the hydrogen fuel cell, the water byproduct of operation is captured and stored in on-board water tank(s) 340. The tank(s) 340 has heating element(s) H used to maintain the temperature of the water in the tank(s) 340 above freezing in cases where the outside temperature is below freezing. The storage tank(s) 340 can have a UV light or other means of reducing microbial growth in the water, if needed.

The water storage tank(s) 340 contains an evacuation tube (not shown) or drainage port to allow the removal of water, if needed. It may be desirable to remove the water if the vehicle 305 is refueled by adding formic acid fuel to the liquid fuel tank at a refueling station. The water can be a source of purified water for the fueling station to recycle for further fuel generation. The tank(s) 340 would also have a purified water filling port to resupply the water tank(s) 340, if needed. One method of removing the water is supplying a vacuum to the evacuation tube, although other methods such as pumps or gravity drainage are also possible.

Besides home refueling, the system 300 would have the ability to supply formic acid directly to the liquid storage tank(s) 322. The liquid fuel would bypass the liquid supply pump(s) 324 seen in FIG. 3.

The fuel cell(s) 320 would be equipped with the necessary equipment, such as gauges, meters, pressure equalizers, and pumps, to allow the fuel cell 320 to run in the electrolyzer mode. For home refueling, an external power source would be connected to the vehicle. An external power port 345 may use the same technology as the electric ports on electric vehicles. If needed, the efficiency of formic acid generation can be improved by heating the water using the water tank heating element H.

Water and CO2 are fed to the fuel cell(s) 320 when in the electrolyzer mode (FIG. 4). The electrolysis process generates formic acid and oxygen gas. The oxygen gas is vented to the atmosphere. The liquid formic acid is fed to the liquid storage tank(s) 322 by pump(s) 324. The gas can to be pressured to approximately 5,000 to 10,000 psi. One method for accomplishing this is shown in FIG. 4 through the use of gas compression pumps 310 and surge tank(s) 380.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

We claim:

1. A fuel cell vehicle on-board system for a fuel cell vehicle powered by an electric motor, comprising:
one or more reversible fuel cells powered by compressed hydrogen gas and oxygen, the one or more reversible fuel cells supplying power to the electric motor in a power mode and supply hydrogen gas in an electrolyzer mode;
a water supply and capture system to supply water to the one or more reversible fuel cells in an electrolyzer mode and capture water from the one or more reversible fuel cells in a power mode, where water is the byproduct of the hydrogen-oxygen reaction in the one or more reversible fuel cells;
a hydrogen gas supply and capture system to capture hydrogen gas from the one or more reversible fuel cells in the electrolyzer mode and supply hydrogen gas to the one or more reversible fuel cells in a power mode;
one or more electrical connectors for externally supplying electrical power to the one or more reversible fuel cells to power the one or more reversible fuel cells in the electrolyzer mode to supply hydrogen gas to the hydrogen gas supply and capture system.

2. The fuel cell vehicle on-board system of claim 1, wherein the hydrogen gas supply and capture system includes one or more on-board hydrogen gas tanks that store hydrogen gas in the fuel cell vehicle, and one or more pumps that draw hydrogen gas from and deliver hydrogen gas to the one or more on-board hydrogen gas tanks, and compress the hydrogen gas generated by the one or more reversible fuel cells.

3. The fuel cell vehicle on-board system of claim 1, wherein the water supply and capture system includes one or more on-board water tanks that store water in the fuel cell vehicle, and one or more pumps to draw water from and deliver water to the water tank.

4. The fuel cell vehicle on-board system of claim 3, wherein the water supply and capture system includes one or more heating elements to heat the water in the water tank.

5. The fuel cell vehicle on-board system of claim 1, further including a vent that in the electrolyzer mode allows oxygen gas by-product from the one or more reversible fuel cells to be vented to the atmosphere.

6. The fuel cell vehicle on-board system of claim 1, further including a connection so that the hydrogen gas supply and capture system can be filled from an external gas source such as a hydrogen filling station.

7. The fuel cell vehicle on-board system of claim 1, wherein the fuel cell vehicle is a hybrid fuel cell electric vehicle including a rechargeable power source, and the one or more electrical connectors are also used for charging the rechargeable power source of the hybrid fuel cell electric vehicle.

8. The fuel cell vehicle on-board system of claim 1, wherein the one or more reversible fuel cells each include a power rating greater than 5 kW.

9. The fuel cell vehicle on-board system of claim 8, wherein the one or more reversible fuel cells each include a power rating greater of about 100 kW.

10. A method of at-home refueling of a fuel cell vehicle having the fuel cell vehicle on-board system of claim 1, comprising;
supplying water from the water supply and capture system to the one or more reversible fuel cells;
at home, coupling an electric source with the one or more reversible fuel cells with the one or more electrical connectors to externally supply electrical power to the one or more reversible fuel cells to power the one or more reversible fuel cells in an electrolyzer mode;
converting stored water to hydrogen gas with the one or more reversible fuel cells in an electrolyzer mode;
supplying hydrogen gas from the one or more reversible fuel cells in an electrolyzer mode to the hydrogen gas supply and capture system;
storing hydrogen gas in the hydrogen gas supply and capture system.

11. The method of at-home refueling of a fuel cell vehicle of claim 10, wherein the hydrogen gas supply and capture system includes an on-board pressurized storage tank, and storing hydrogen gas includes storing hydrogen gas in the on-board pressurized storage tank.

12. The method of at-home refueling of a fuel cell vehicle of claim 10, wherein the fuel cell vehicle on-board system is capable of refueling the hydrogen gas supply and capture system in a 12 hour period.

13. The method of at-home refueling of a fuel cell vehicle of claim 10, further comprising regenerative breaking using the electric motor, supplying electrical power to the one or more reversible fuel cells to power the one or more reversible fuel cells in the electrolyzer mode to supply hydrogen gas to the hydrogen gas supply and capture system.

14. The method of at-home refueling of a fuel cell vehicle of claim 10, wherein the water supply and capture system includes an on-board tank in the vehicle, and the water generated by the one or more reversible fuel cells in the power mode is stored in the on-board tank in the vehicle.

15. The method of at-home refueling of a fuel cell vehicle of claim 10, wherein the water supply and capture system includes a heater to electrically heat the water in the on-board tank to at least one of prevent freezing in cold weather and improve electrolysis efficiency.

16. The method of at-home refueling of a fuel cell vehicle of claim 10, further comprising venting oxygen supplied by the one or more reversible fuel cells in an electrolyzer mode is vented to the atmosphere.

17. The method of at-home refueling of a fuel cell vehicle of claim 10, wherein the hydrogen gas supply and capture system includes one or more gas compression pumps and one or more surge tanks, the method further comprising pressurizing the hydrogen gas using the hydrogen gas supply and capture system to approximately 5,000 to 10,000 psi.

18. The method of at-home refueling of a fuel cell vehicle of claim 10, wherein the fuel cell vehicle on-board system further includes a connection so that the hydrogen gas supply and capture system can be filled from an external gas source such as a hydrogen filling station, and the method further comprising refilling the hydrogen gas supply and capture system with hydrogen gas from the hydrogen filling station via the connection.

19. The method of at-home refueling of a fuel cell vehicle of claim 10, wherein the fuel cell vehicle is a hybrid fuel cell electric vehicle including a rechargeable power source, and the method further comprising using the one or more electrical connectors for charging the rechargeable power source of the hybrid fuel cell electric vehicle.

20. The method of at-home refueling of a fuel cell vehicle of claim 10, wherein the one or more reversible fuel cells each include a power rating greater than 5 kW.
